(19) United States
(12) Patent Application Publication
(10) Pub. No.: US 2014/0209145 A1
(43) Pub. Date: Jul. 31, 2014

(54) PHOTOVOLTAIC DEVICE WITH DEBRIS CLEANING ASSEMBLY

(71) Applicant: HON HAI PRECISION INDUSTRY CO., LTD., New Taipei (TW)

(72) Inventors: YU-CHEN TING, New Taipei (TW); CHIH-HANG CHAO, New Taipei (TW)

(73) Assignee: HON HAI PRECISION INDUSTRY CO., LTD., New Taipei (TW)

(21) Appl. No.: 14/082,361

(22) Filed: Nov. 18, 2013

(30) Foreign Application Priority Data
Jan. 29, 2013 (TW) 102103373

(51) Int. Cl. H01L 31/042

(52) U.S. Cl. CPC H02S 40/00
USPC 136/244

(57) ABSTRACT

A photovoltaic device includes a solar panel and a cleaning assembly. The cleaning assembly includes a driving member, a transmission member, and a wiper fixed to the transmission member and attached to the solar panel. The transmission member is driven by the driving member. The transmission member moves relative to the solar panel. The wiper is moved to wipe debris on the solar panel.

### CROSS-REFERENCE TO RELATED APPLICATIONS

This application claims all benefits accruing under 35 U.S.C. §119 from Taiwan Patent Application No. 102103373, filed on Jan. 29, 2013, in the Taiwan

Intellectual Property Office, the contents of which are hereby incorporated by reference. Relevant subject matter is disclosed in co-pending U.S. Patent Applications entitled “PHOTOVOLTAIC DEVICE WITH DEBRIS CLEANING ASSEMBLY,” Attorney Docket Number US49752, U.S. application No. ______, filed on ______.

### BACKGROUND

1. Technical Field

The present disclosure relates to photovoltaic devices, and more particularly to a photovoltaic device having a debris cleaning assembly.

2. Description of Related Art

A photovoltaic device employs solar panels to generate electrical power. However, the photovoltaic device must be located outdoors, so foreign matter, such as snow or dust, may pile on the solar panel, thereby reducing the solar panel's ability to receive sunlight. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is an isometric, exploded view of an embodiment of a photovoltaic device having a cleaning assembly.

FIG. 2 is a block view of working modules connected to a debris detecting module of the photovoltaic device in FIG. 1.

FIG. 3 is an assembled view of the photovoltaic device having debris piled thereon.

FIG. 4 is similar to FIG. 3, but showing a wiper of the photovoltaic device in another state.

FIG. 5 is a second embodiment of a photovoltaic device having a cleaning assembly.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

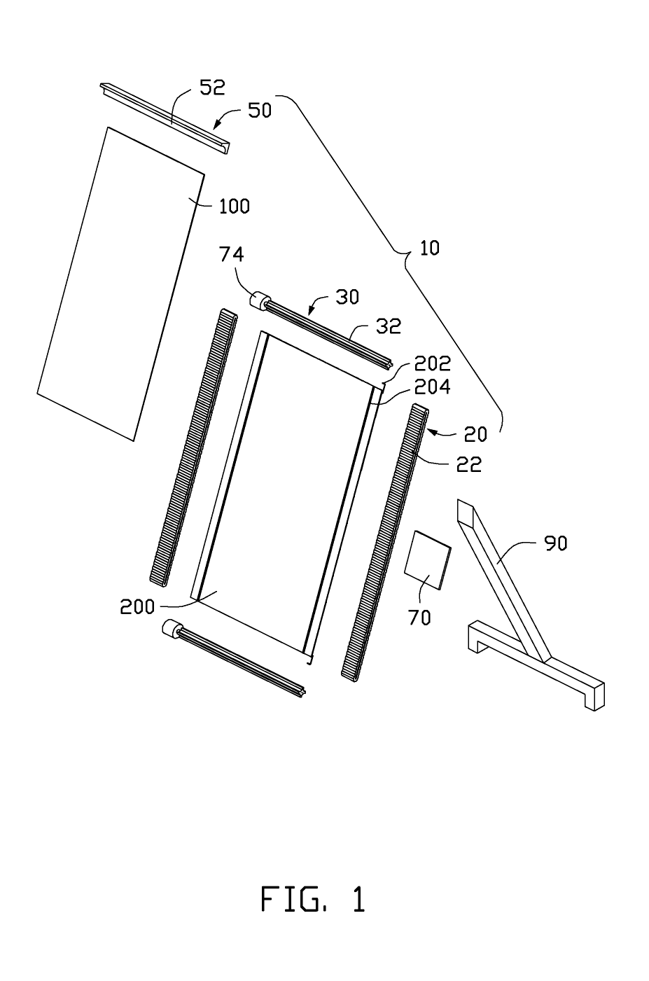

FIG. 1 illustrates an embodiment of a photovoltaic device. The photovoltaic device includes a solar panel 100, a cleaning assembly 10, and a stand 90.

The cleaning assembly 10 includes two transmission members 20, two driving members 30, a wiper 50, a debris detecting module 70, and a rear plate 200. The solar panel 100 and the cleaning assembly 10 are angled relative to a horizontal plane. The solar panel 100 is fixed to the rear plate 200. The rear plate 200 includes two supporting members 202.

In one embodiment, each transmission member 20 is a transmission belt. Each transmission member 20 extends around a longitudinal direction of the rear plate 200. The transmission members 20 may be attached to the rear plate 200 through two slides 204. The two transmission members 20 are located at two lateral sides of the solar panel 100, respectively. Each transmission member 20 includes a plurality of engaging tabs 22.

Each driving member 30 is substantially rod-shaped and driven by a motor 74. The motor 74 may be secured to the rear plate 200. Each driving member 30 includes a plurality of driving portions 32 to engage with the plurality of engaging tabs 22 of the transmission members 20.

A cross-section of the wiper 50 is substantially L-shaped. The wiper 50 defines an arcuate guiding surface 52.

The debris detecting module 70 determines a weight of debris, such as dust or snow, piled on the solar panel 100.

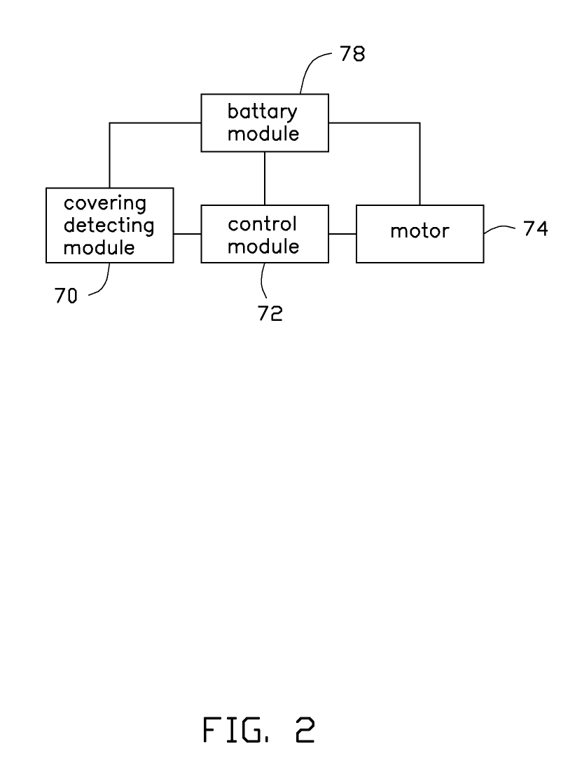

FIG. 2 illustrates working modules connected to the debris detecting module 70. A control module 72 is connected to the debris detecting module 70. The motor 74 is connected to the control module 72. A battery module 78 is connected to the debris detecting module 70, the control module 72, and the motor 74. The control module 72 controls the motor 74 to work when the debris detecting module 70 detects the debris on the solar panel 100. Electric power of the battery module 78 is supplied by the solar panel 100.

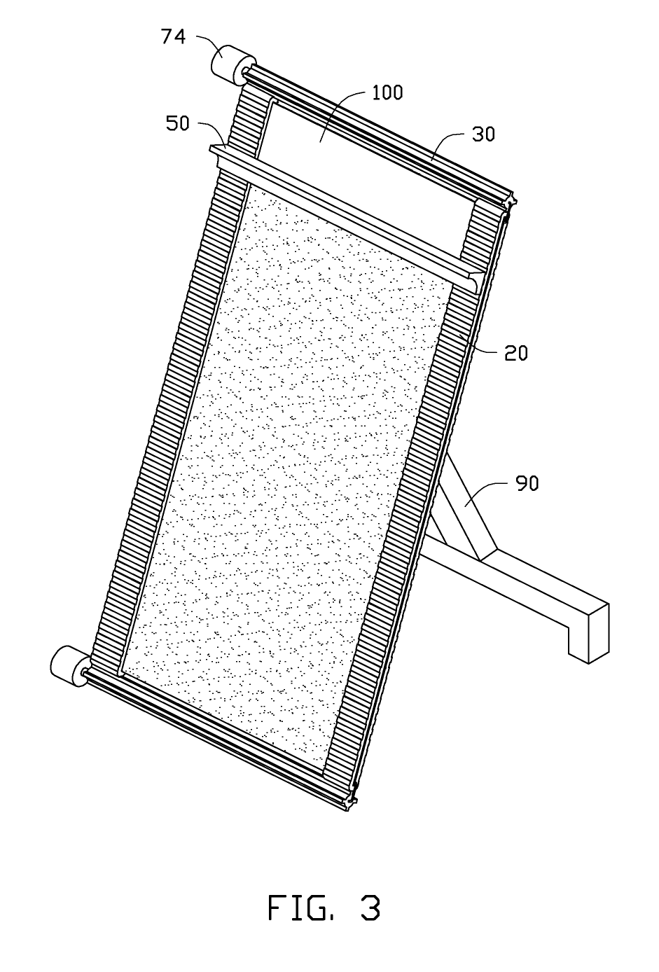

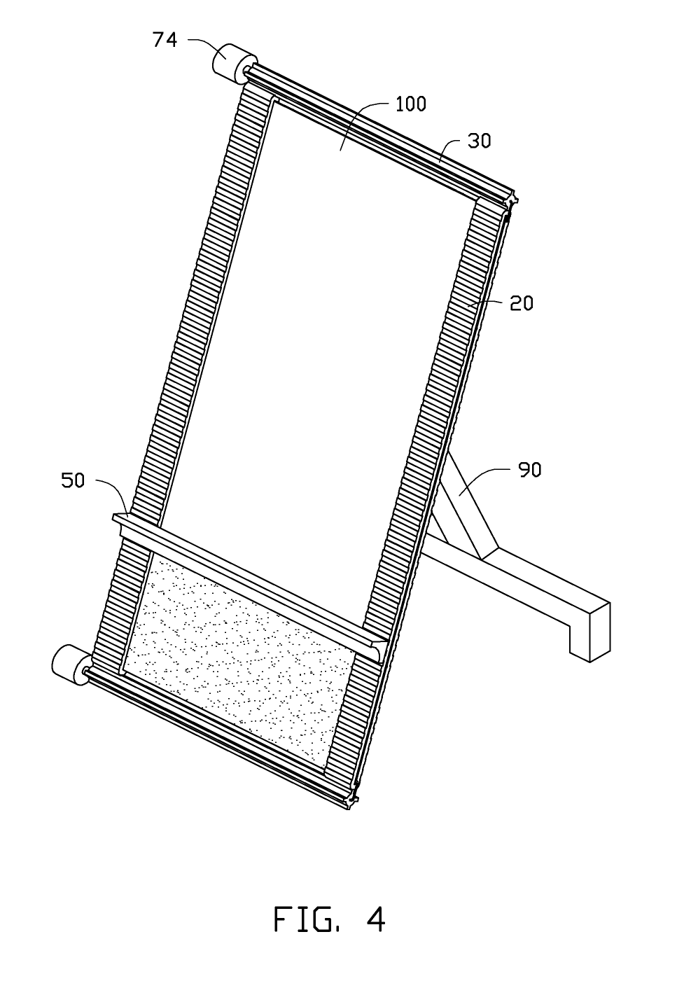

FIGS. 3 and 4 illustrate two working states of the photovoltaic device. In assembly, the solar panel 100 is mounted to the rear plate 200. The two transmission members 20 are mounted around two lateral sides of the solar panel 100. The driving members 30 are mounted to opposite sides of the solar panel 100, such that the two driving members 30 are engaged with the two transmission members 20. The wiper 50 is fixed to the two transmission members 20 along a widthwise direction of the solar panel 100. The wiper 50 contacts the solar panel 100. The stand 90 supports a back side of the rear plate 200. The debris detecting module 70 is located between the solar panel 100 and the stand 90.

In use, when debris piles on the solar panel 100, the debris detecting module 70 detects a weight of the debris on the solar panel 100. When the detected weight exceeds a predetermined weight, the control module 72 controls the motor 74 to rotate the driving members 30. The transmission members 20 are driven to rotate around the longitudinal direction of the solar panel 100, causing the wiper 50 to wipe away the debris from the solar panel 100.

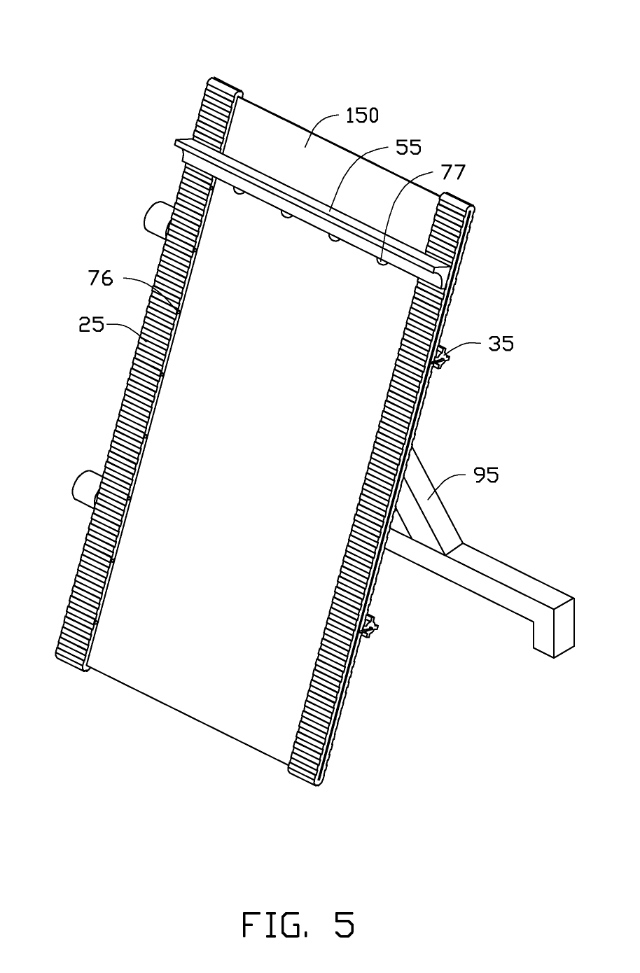

FIG. 5 illustrates a second embodiment of a photovoltaic device. Two driving members 35 are mounted to a rear side of two transmission members 25. A plurality of infrared detecting modules 76 is located on an inner side of each transmission member 25 to detect debris on a solar panel 150. A plurality of sprayers 77 is located on a wiper 55 to spray a cleanser on the solar panel 150.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A photovoltaic device comprising:
a solar panel; and
a cleaning assembly comprising:
a driving member;
a transmission member driven by the driving member; and
a wiper fixed to the transmission member and attached to the solar panel;
wherein the transmission member moves relative to the solar panel, and the wiper is configured to be moved and wipe a debris on the solar panel.

2. The photovoltaic device of claim 1, wherein the wiper is substantially bar-shaped, and a cross-section of the wiper is substantially L-shaped.

3. The photovoltaic device of claim 2, wherein the wiper defines a substantially arcuate guiding surface for guiding the debris.

4. The photovoltaic device of claim 1, wherein the driving member comprises a driving portion, the transmission member comprises a plurality of engaging tabs, and the plurality of engaging tabs is spaced and is engaged with the driving portion.

5. The photovoltaic device of claim 1, wherein the transmission member is located on a lateral side of the solar panel.

6. The photovoltaic device of claim 1, further comprising a rear plate attached to the solar panel, wherein the transmission member extends around the rear plate.

7. The photovoltaic device of claim 1, further comprising an infrared detecting device, wherein the infrared detecting device is located on a lateral side of the transmission member towards the solar panel.

8. The photovoltaic device of claim 1, further comprising a debris detecting module and a stand, wherein the debris detecting module is located between the solar panel and the stand to detect weight of the debris on the solar panel.

9. The photovoltaic device of claim 8, wherein the driving member is driven by a motor, and electric power of the motor and the debris detecting module are supplied by the solar panel.

10. The photovoltaic device of claim 1, wherein the wiper comprising a sprayer towards the solar panel to spray a cleanser.

11. A photovoltaic device comprising:
a solar panel; and
a cleaning assembly comprising:
a driving member;
a transmission member extending along a longitude direction relative to the solar panel and is driven by the driving member; and
a wiper fixed to the transmission member, the wiper contacting with the solar panel and extending along a latitude direction relative to the solar panel;
wherein the wiper is configured to be moved along a straight direction to wipe a debris on the solar panel.

12. The photovoltaic device of claim 11, wherein the wiper is substantially bar-shaped, and a cross-section of the wiper is substantially L-shaped.

13. The photovoltaic device of claim 12, wherein the wiper defines a substantially arcuate guiding surface for guiding the debris.

14. The photovoltaic device of claim 11, wherein the driving member comprises a driving portion, the transmission member comprises a plurality of engaging tabs, and the plurality of engaging tabs is spaced and is engaged with the driving portion.

15. The photovoltaic device of claim 11, wherein the transmission member is located on a lateral side of the solar panel.

16. The photovoltaic device of claim 11, further comprising a rear plate attached to the solar panel, wherein the transmission member extends around the rear plate.

17. The photovoltaic device of claim 11, further comprising an infrared detecting device, wherein the infrared detecting device is located on a lateral side of the transmission member towards the solar panel.

18. The photovoltaic device of claim 11, further comprising a debris detecting module and a stand, wherein the debris detecting module is located between the solar panel and the stand to detect weight of the debris on the solar panel.

19. The photovoltaic device of claim 18, wherein the driving member is driven by a motor, and electric power of the motor and the debris detecting module are supplied by the solar panel.

20. The photovoltaic device of claim 11, wherein the wiper comprising a sprayer towards the solar panel to spray a cleanser.
